(19) United States
(12) Patent Application Publication
(10) Pub. No.: US 2022/0239424 A1
(43) Pub. Date: Jul. 28, 2022

(54) SINGLE CARRIER PDCCH TRANSMISSION AND RECEPTION

(71) Applicant: Nokia Technologies Oy, Espoo (FI)

(72) Inventors: Esa Tapani TIIROLA, Kempele (FI); Kari Juhani HOOLI, Oulu (FI); Kari Pekka PAJUKOSKI, Oulu (FI)

(21) Appl. No.: 17/610,549

(22) PCT Filed: May 15, 2019
(86) PCT No.: PCT/EP2019/062501

§ 371 Date: Nov. 11, 2021

(51) Int. Cl. H04L 5/00

(52) U.S. Cl. CPC H04L 5/0044; H04L 5/0051; H04L 5/0053

(57) ABSTRACT

Devices, methods and computer programs are disclosed for enabling single carrier transmission of multiple downlink control information blocks. A network and client devices may operate according to multiple search space configurations. A first search space configuration may be used to transmit and receive downlink control data containing a single downlink control information block. A second search space configuration may be used to transmit and receive downlink control data containing multiple downlink control information blocks.

### TECHNICAL FIELD

The present application generally relates to the field of wireless communications. In particular, the present application relates to a client device and a network node device for wireless communication, and a related methods and a computer programs.

### BACKGROUND

In various wireless communication technologies, such as long-term evolution (LTE) 4G and new radio (NR) 5G, a client device, such as a mobile phone, and a network node device, such as a base station, may use a physical downlink control channel to schedule uplink and downlink data channels. Information carried on physical downlink control channel may be referred to as downlink control information.

### SUMMARY

The scope of protection sought for various embodiments of the invention is set out by the independent claims. The example embodiments and features, if any, described in this specification that do not fall under the scope of the independent claims are to be interpreted as examples useful for understanding various embodiments of the invention.

An example embodiment of an apparatus comprises at least one processor and at least one memory including computer program code. The at least one memory and the computer program code are configured to, with the at least one processor, cause the apparatus to: receive a first search space configuration associated with a first set of physical layer resources; receive a second search space configuration associated with a second set of physical layer resources; receive a single carrier signal and monitor a set of physical downlink resources in the single carrier signal according to the first search space configuration and the second search space configuration; in response to finding first payload data corresponding to the first search space configuration, operate according to a downlink control information block comprised in the first payload data; and in response to finding second payload data corresponding to the second search space configuration, wherein the second payload data comprises a plurality of time division multiplexed downlink control information blocks, determine presence of at least one dedicated downlink control information block in the plurality of downlink control information blocks and operating according to the dedicated downlink control information block.

An example embodiment of a method: receiving a first search space configuration associated with a first set of physical layer resources; receiving a second search space configuration associated with a second set of physical layer resources; receiving a single carrier signal and monitoring a set of physical downlink resources in the single carrier signal according to the first search space configuration and the second search space configuration; in response to finding first payload data corresponding to the first search space configuration, operating according to a downlink control information block comprised in the first payload data; and in response to finding second payload data corresponding to the second search space configuration, wherein the second payload data comprises a plurality of time division multiplexed downlink control information blocks, determining presence of at least one dedicated downlink control information block in the plurality of downlink control information blocks and operating according to the dedicated downlink control information block.

An example embodiment of an apparatus comprises means for receiving a first search space configuration associated with a first set of physical layer resources; means for receiving a second search space configuration associated with a second set of physical layer resources; means for receiving a single carrier signal and monitoring a set of physical downlink resources in the single carrier signal according to the first search space configuration and the second search space configuration; in response to finding first payload data corresponding to the first search space configuration, means for operating according to a downlink control information block comprised in the first payload data; and in response to finding second payload data corresponding to the second search space configuration, wherein the second payload data comprises a plurality of time division multiplexed downlink control information blocks, means for determining presence of at least one dedicated downlink control information block in the plurality of downlink control information blocks and operating according to the dedicated downlink control information block.

An example embodiment of a computer program comprises program code configured to cause performance of the method according to any of the example embodiments described herein, when the computer program is executed on a computer.

An example embodiment of an apparatus comprises at least one processor and at least one memory including computer program code. The at least one memory and the computer program code are configured to, with the at least one processor, cause the apparatus to: transmit a first search space configuration; transmit a second search space configuration; and transmit, in a set of physical downlink resources of a single carrier signal, first payload data corresponding to the first search space configuration and second payload data corresponding to the second search space configuration, wherein the first payload data comprises a downlink control information block and the second payload data comprises a plurality of time division multiplexed downlink control information blocks.

An example embodiment of a method comprises transmitting a first search space configuration; transmitting a second search space configuration; and transmitting, in a set of physical downlink resources of a single carrier signal, first payload data corresponding to the first search space configuration and second payload data corresponding to the second search space configuration, wherein the first payload data comprises a downlink control information block and the second payload data comprises a plurality of time division multiplexed downlink control information blocks.

An example embodiment of an apparatus comprises means for transmitting a first search space configuration; means for transmitting a second search space configuration; and means for transmitting, in a set of physical downlink resources of a single carrier signal, first payload data corresponding to the first search space configuration and second payload data corresponding to the second search space configuration, wherein the first payload data comprises a downlink control information block and the second payload data comprises a plurality of time division multiplexed downlink control information blocks.

An example embodiment of a computer program comprises program code configured to cause performance of the method according to any of the example embodiments described herein, when the computer program is executed on a computer.

### DESCRIPTION OF THE DRAWINGS

The accompanying drawings, which are included to provide a further understanding of the example embodiments and constitute a part of this specification, illustrate example embodiments and together with the description help to explain the principles of the example embodiments. In the drawings:

FIG. 1 shows an example embodiment of the subject matter described herein illustrating an example system, where various embodiments of the present disclosure may be implemented;

FIG. 2A shows an example embodiment of the subject matter described herein illustrating an apparatus;

FIG. 2B shows an example embodiment of the subject matter described herein illustrating an apparatus;

FIG. 3 illustrates an example of generating a single carrier PDCCH signal, according to an embodiment.

FIG. 4 illustrates an example of two search space configurations, according to an embodiment.

FIG. 5 shows an example embodiment of the subject matter described herein illustrating a signaling diagram between a network and client devices; and

FIG. 6 shows an example embodiment of the subject matter described herein illustrating a downlink payload.

FIG. 7 shows an example of a method for finding downlink control information, according to an embodiment.

FIG. 8 shows an example of a method for providing downlink control information, according to an embodiment.

Like reference numerals are used to designate like parts in the accompanying drawings.

### DETAILED DESCRIPTION

Reference will now be made in detail to example embodiments, examples of which are illustrated in the accompanying drawings. The detailed description provided below in connection with the appended drawings is intended as a description of the present examples and is not intended to represent the only forms in which the present disclosure may be constructed or utilized. The description sets forth the functions of the example and the sequence of steps for constructing and operating the example. However, the same or equivalent functions and sequences may be accomplished by different examples embodiments.

According to an example embodiment, a client device may be configured to operate according to a plurality of search space configurations. A first search space configuration may be used to discover control data containing a single downlink control information block. A second search space configuration, which the client device may monitor in parallel with the first search space configuration, may be used to discover control data containing multiple downlink control information blocks. The second search space configuration may advantageously enable transmission and reception of multiple downlink control information blocks in single carrier signal. This provides for example the benefit of improved peak-to-average power ratio of the generated signal, which enables to improve reception performance at cell edge. A network node may dynamically switch between transmitting downlink control information according to the first and second search space configurations, for example single-DCI and multi-DCI, respectively. This provides for example the benefit of improved flexibility in the transmission system.

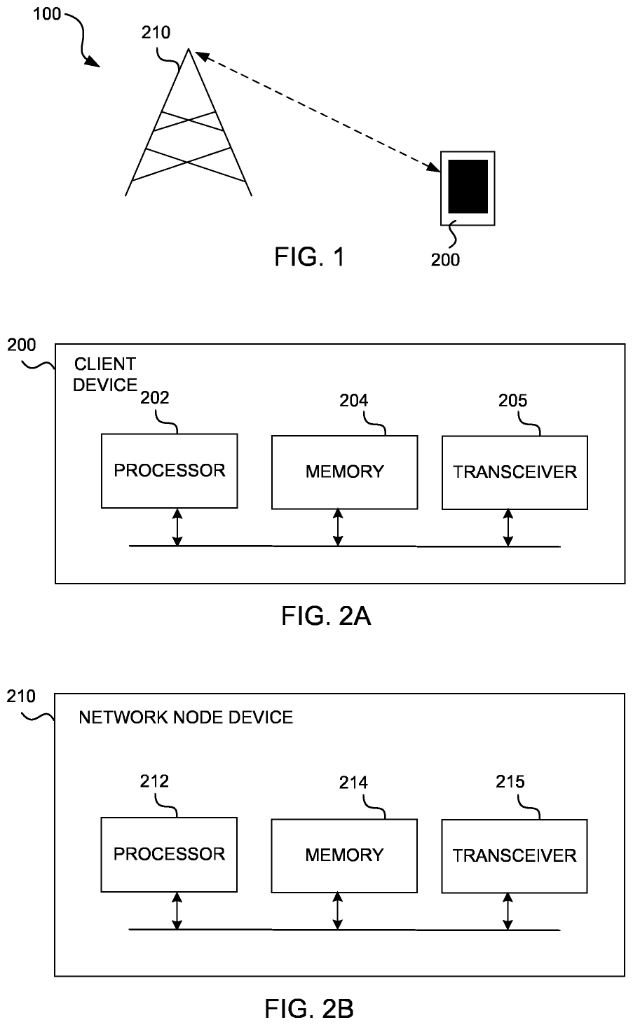

FIG. 1 illustrates an example system 100, where various example embodiments of the present disclosure may be implemented. An example representation of the system 100 is shown depicting a client device 200, and a network node device 210.

The client device 200 may include e.g. a mobile phone, a smartphone, a tablet computer, a smart watch, an Internet of Things (IoT) device or any hand-held or portable device. Examples of IoT devices include, but are not limited to, consumer electronics, wearables, and smart home appliances. In one example, apparatus 200 may comprise a vehicle such as for example a car. The client device 200 may also be referred to as a user equipment (UE). The client device 200 may communicate with the network node device 210 directly, or via e.g. an air/space born vehicle communication connection, such as a service link.’ In an example embodiment, the client device 200 corresponds to Mobile Termination (MT) part of the Integrated and Access and backhaul (IAB) node (i.e. user equipment part of relay node functionality being specified as part of NR Rel-16). The network node device (210) may be also Distributed Unit (DU) part of IAB node (i.e. gNB part of relay node functionality).

The client device 200 and the network node device 210 may be configured to operate according to various radio standards, for example 3GPP 5^{th} Generation New Radio standard (5G NR). For example, a physical downlink control channel, PDCCH, of 5G NR may be used to schedule uplink and downlink data channels.

A PDCCH may comprise one or more control-channel elements (CCE). A number of CCEs in a PDCCH may be referred to as an aggregation level. For example, aggregation levels 1, 2, 4, 8, 16, and 32 may refer to 1, 2, 4, 8, 16, and 32 CCEs in a PDCCH, respectively. A CCE may comprise one or more resource element groups (REG), for example six REGs. A resource element group may comprise one or more resource element, which may refer to one subcarrier during one symbol, for example an orthogonal frequency division multiplexing (OFDM) symbol or a single carrier frequency division multiplexing (SC-FDMA) symbol. In some scenarios, multiple adjacent REGs in frequency and/or time may be grouped together to form a REG bundle. Some functionalities of the PDCCH, such as interleaved resource mapping and precoder cycling granularity may be determined based on REG bundle. For example, UE may assume that gNB utilizes the same beamforming weights for all REGs/REs of a REG bundle.

Information carried on PDCCH may be referred to as downlink control information, DCI. To receive DCI on NR PDCCH, a client device 200 may monitor a set of PDCCH candidates in the one or more configured monitoring occasions in one or more configured COntrol REsource SETs, CORESETs, according to, for example, search space, SS, configurations. CORESET or a CORESET configuration may comprise a set of physical resources, such as a specific frequency/time resources on NR downlink resource (slot) grid, and a set of parameters that is used to carry PDCCH/DCI. Search space may also be referred to as search space set or similar.

5G NR physical layer channels were designed and optimized for below 52.6 GHz scenarios. The frequencies beyond that may contain large spectrum allocations and may not support many high capacity use cases. Potential high mm-wave bands for 5G and beyond systems may be, for example, 70/80/92-114 GHz.

For frequencies above 52.6 GHz, the client device 200 and/or the network node device 210 may have to cope with increased path loss, larger antenna arrays, and less efficient RF components like power amplifiers, PAs. Hence, the systems above 52.6 GHz may be more noise limited especially at cell edges, which may drive the need to obtain more power from the PAs. The Single carrier, SC, waveform may be preferred over orthogonal frequency-division multiplexing, OFDM, because of its low peak-to-average power ration, PAPR, properties. The low PAPR waveform may enable the PAs to be run at a higher power to maintain coverage. However, the cyclic prefix OFDM, CP-OFDM, modulation may still be beneficial for non-power limited client devices 200, e.g., due to higher spectral efficiency at high modulation and coding scheme, MCS, and/or multiple-input and multiple-output, MIMO, order for the same receiver complexity. Thus, it is likely that the SC based waveform may be beneficial for downlink in order to maximize coverage and power amplifier efficiency, but the OFDM will remain.

The CP-OFDM and related physical layer channel design for below 52.6 GHz may be reused also for above 52.6 GHz scenarios. This can be achieved, for example, by means of scalable frame structure with scalable numerology and new numerology options with higher subcarrier spacing, such as 960 kHz. However, a problem may arise from high peak-to-average ratio, PAR, of control channels such as physical broadcast channel, PBCH, and PDCCH because they have been designed for OFDM.

PDCCH could support single carrier-based transmission by, for example, the following modifications. The resource element group (and/or REG bundle) structure may be redesigned to implement time-division multiplexing between demodulation reference signal, DMRS, and DCI. At least 2 OFDM/SC symbols may be required in the CORESET. Support for only non-interleaved control channel element to resource element group, CCE-to-REG, mapping may be required (at least for the case of single carrier PDCCH). Support for only wideband DMRS where the precoder cycling at the gNB transmitter does not vary in frequency from REG-to-REG may be required or a new transmission diversity scheme may need to be defined maintaining single carrier properties.

Furthermore, with single carrier PDCCH, multiplexing capacity may be limited. For example, that the network node device 210 may need to transmit two PDCCHs to two client devices 200 via a transceiver. The two PDCCHs may occupy contiguous resources of the CORESET in the frequency. Since two PDCCHs are created by two separate discrete Fourier transforms DFTs, the signal cannot be considered as single carrier (or serial modulation) anymore. This may mean that PAPR of the transmitted signal is increased considerably compared to the scenario where only one PDCCH is transmitted.

Some terminology used herein may follow the naming scheme of 4G or 5G technology in its current form. However, this terminology should not be considered limiting, and the terminology may change over time. Thus, the following discussion regarding any example embodiment may also apply to other technologies.

Some example embodiments described herein may address the problem of how to support transmission of a plurality of DCIs via CORESET(s) configured to operate according to single carrier PDCCH.

Some example embodiments described herein may address the problem of how to improve the coverage for different scenarios involving varying number of PDCCHs to be transmitted via a single CORESET.

Separate CORESETs could be used for each PDCCH. Problem of this approach may be an increased control channel overhead and reduced multiplexing capacity. Scalability may also be poor, since each additional PDCCH would require a separate CORESET.

Alternatively, each PDCCH may be allocated to different beams (and different transceivers). This may be a good component of single carrier PDCCH. However, this may not be a sufficient solution alone, since it may suffer from the scalability issue. PDCCH capacity may still be limited to the number of Tx beams. Furthermore, this may not allow usage of the same beam for a plurality of DCIs.

FIG. 2A is a block diagram of an apparatus, for example a client device 200, in accordance with an example embodiment.

The client device 200 comprises one or more processors 202, and one or more memories 204 that comprise computer program code. The client device 200 may also include a transceiver 205, as well as other elements, such as an input/output module (not shown in FIG. 2A), and/or a communication interface (not shown in FIG. 2A).

Although the client device 200 is depicted to include only one processor 202, the client device 200 may include more processors. In an example embodiment, the memory 204 is capable of storing instructions, such as an operating system and/or various applications.

Furthermore, the processor 202 is capable of executing the stored instructions. In an example embodiment, the processor 202 may be embodied as a multi-core processor, a single core processor, or a combination of one or more multi-core processors and one or more single core processors. For example, the processor 202 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an example embodiment, the processor 202 may be configured to execute hard-coded functionality. In an example embodiment, the processor 202 is embodied as an executor of software instructions, wherein the instructions may specifically configure the processor 202 to perform the algorithms and/or operations described herein when the instructions are executed.

The memory 204 may be embodied as one or more volatile memory devices, one or more non-volatile memory devices, and/or a combination of one or more volatile memory devices and non-volatile memory devices. For example, the memory 204 may be embodied as semiconductor memories (such as mask ROM, PROM (programmable ROM), EPROM (erasable PROM), flash ROM, RAM (random access memory), etc.).

The client device 200 may be any of various types of devices used directly by an end user entity and capable of communication in a wireless network, such as user equipment (UE). Such devices include but are not limited to smartphones, tablet computers, smart watches, lap top computers, Internet-of-Things (IoT) devices, MT part of IAB node, etc.

The at least one memory 204 and the computer program code are configured to, with the at least one processor 202, cause performance of an apparatus, for example client device 200, as described in the appended claims and throughout the specification.

Receiving a configuration may comprise receiving information indicating the configuration, for example a search space, aggregation level, and/or any other parameter disclosed herein.

A downlink control information block may comprise downlink control information. Downlink control information may refer to DCI in the case of 4G and/or 5G technology. Downlink control information may also refer to similar information in other technologies regardless of the terminology used for that technology. The first payload data may comprise a single downlink control information block. Any disclosure herein related DCI may also apply to downlink control information or similar information in other technologies.

A search space identification may identify a search space that the client device 200 can search to find the physical downlink control channel. The search space may comprise a plurality of resource elements and/or resource element groups and/or resource element group bundles. The client device 200 may be configured to search the search space indicated by the search space identification in order to find the first payload data and/or the second payload data.

The first physical downlink control channel configuration and/or the second physical downlink control channel configuration may refer to, for example, PDCCH configuration in the case of 5G technology. The first physical downlink control channel configuration and/or the second physical downlink control channel configuration may also refer to similar information/configuration in other technologies regardless of the terminology used for that technology. Any disclosure herein related PDCCH configuration may also apply to physical downlink control channel configuration or similar information in other technologies.

The first payload data and/or the second payload data may comprise data transmitted via PDCCH in the case of 5G technology. Herein, such payload may also be referred to as PDCCH payload, PDCCH payload data, or similar. The first payload data and/or the second payload data may also refer to similar information/configuration in other technologies regardless of the terminology used for that technology.

The set of physical downlink resources may comprise, for example, one or more CORESETs in the case of 5G technology. The set of physical downlink resources may also refer to similar resources in other technologies regardless of the terminology used for that technology.

When the client device 200 operates according to a downlink control information block, the client device 200 may, for example, deduce which resource block carries data addressed for the client device 200. Furthermore, the client device 200 may deduce which demodulation scheme to use to decode (or encode) the data. For example, which MCS and time/frequency domain resources are used for receiving the Physical Downlink Shared Channel (PDSCH), or transmitting the Physical Uplink Shared Channel (PUSCH)). These are only examples and the client device 200 may perform various operations based on the downlink control information block. In another example embodiment, when the client device 200 operates according to a downlink control information block, the client device 200 may deduce which resource block to use to transmit data from the client device 200 to the network node device 210. Furthermore, the client device 200 may deduce which modulation scheme to use to transmit the data.

Dedicated downlink control information block may refer to downlink control information blocks that are addressed for the client device 200. The client device 200 may detect a dedicated downlink control information block based on, for example, various information, such as for example an identifier or a header, transmitted in/with the downlink control information block.

Aggregation level may indicate how many CCEs are allocated for a PDCCH. Correspondence between the aggregation level and the number of allocated CCE can be defined using, for example, a table.

Size of the second payload data may be indicate, for example, in bits, in bytes, or in any other format.

A radio network temporary identifier (RNTI) can be used to identify UEs, for example UEs in particular cell. A common radio network temporary identification may be common for a plurality of UEs.

Data indicating a structure of the second payload data may comprise, for example, a number of downlink control information blocks in the second payload data. The number of downlink control information blocks may indicate a maximum number of downlink control information blocks.

Additionally, or alternatively, data indicating a structure of the second payload data may comprise, for example, a maximum size of at least one downlink control information block in the second payload data. For example, data indicating a structure of the second payload data may comprise a maximum size each downlink control information block in the second payload data.

Additionally, or alternatively, data indicating a structure of the second payload data may comprise, for example, a starting point of at least one downlink control information block in the second payload data. For example, data indicating a structure of the second payload data may comprise a starting point for each downlink control information block in the second payload data.

Although some payload data may be referred to as “first payload data” and some as “second payload data”, this should not be considered as indication of an order of, for example, received the aforementioned payload data. For example, the client device 200 may receive the second payload data before the first payload data or vice versa. The client device 200 may even only receive the second payload data and operate according to the second payload data.

FIG. 2B is a block diagram of an apparatus, for example a network node device 210, in accordance with an example embodiment.

The network node device 210 comprises one or more processors 212, and one or more memories 214 that comprise computer program code. The network node device 210 may also include a transceiver 215, as well as other elements, such as an input/output module (not shown in FIG. 2B), and/or a communication interface (not shown in FIG. 2B).

Although the network node device 210 is depicted to include only one processor 212, the network node device 210 may include more processors. In an example embodiment, the memory 214 is capable of storing instructions, such as an operating system and/or various applications.

Furthermore, the processor 212 is capable of executing the stored instructions. In an example embodiment, the processor 212 may be embodied as a multi-core processor, a single core processor, or a combination of one or more multi-core processors and one or more single core processors. For example, the processor 212 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an example embodiment, the processor 212 may be configured to execute hard-coded functionality. In an example embodiment, the processor 212 is embodied as an executor of software instructions, wherein the instructions may specifically configure the processor 212 to perform the algorithms and/or operations described herein when the instructions are executed.

The memory 214 may be embodied as one or more volatile memory devices, one or more non-volatile memory devices, and/or a combination of one or more volatile memory devices and non-volatile memory devices. For example, the memory 214 may be embodied as semiconductor memories (such as mask ROM, PROM (programmable ROM), EPROM (erasable PROM), flash ROM, RAM (random access memory), etc.).

The network node device 210 may be a base station. The base station may include e.g. a fifth-generation base station (gNB) or any such device providing an air interface for client devices to connect to the wireless network via wireless transmissions.

The at least one memory 214 and the computer program code are configured to, with the at least one processor 212, cause performance of an apparatus, for example the network node device 210, as described in the appended claims and throughout the specification.

The client device 200 can be configured to operate according to a plurality of search space configurations, for example a first search space configuration and a second search space configuration. In the first configuration, search space for PDCCH may comprise one DCI. Maximum achievable coverage for PDCCH may be achieved due to smaller payload.

In the second configuration, a multi-DCI search space for PDCCH may comprise a plurality of DCIs in the same PDCCH payload. The PDCCH payload may comprise room for multiple DCIs. For example, one downlink grant and one uplink grant for the client device 200. Alternatively, or additionally, the PDCCH payload may comprise a plurality of DCIs for different client devices 200. This may improve capacity for single carrier PDCCH with a plurality of DCIs. It may also facilitate transmission of multiple DCIs during one SC-symbol. Configuration can follow that of the first configuration with additional properties discussed herein.

Herein, search space may refer to PDCCH search space. PDCCH search space may refer to the CCEs or aggregated CCEs in the downlink resource grid where/when the certain PDCCH may be transmitted (or from the client device 200 point of view, CCEs or aggregated CCEs from where/when the UE blindly searches the certain PDCCH). The client device 200 may perform blind decoding throughout this search space trying to find PDCCH data, such as the DCI.

Herein, the term “multi-DCI” may refer to payload data according to the second configuration.

The second configuration may support only high aggregation levels, such as AL 16 or 32. This may ensure that coding rate for the multi-DCI payload data remains sufficient. Due to single carrier limitation there may be no need for frequency-division multiplexing, FDM, between parallel DCIs within a beam.

In an example embodiment, the second configuration is based on DCI transmission via the full or half CORESET.

In another example embodiment, both the first configuration and the second configuration are based on DCI transmission via the full or half CORESET.

The second configuration and/or the first configuration may support only limited number of blind decoding candidates per a search space, for example, one or two candidates could be enough.

The client device 200 can be configured with search spaces corresponding to both the first configuration and the second configuration. Hence, the network node device 210 can select the DCI principle dynamically and dynamically switch between transmitting single/multi-DCI payload data according to the first search space configuration and the second search space configuration. This may be done separately for different transmission beams or beam pairs of the network node device 210. Furthermore, there can be a plurality of parallel search spaces configured for a client device 200 according to the first configuration and/or the second configuration, each with different DCI/multi-DCI PDCCH payload.

In some example embodiments, the second configuration comprises at least one of the following parameters: a search space identification, an aggregation level, a size for the PDCCH payload, an RNTI for the PDCCH payload, structure of the PDCCH payload. The structure of the PDCCH payload comprise at least one of: the number of individual DCIs carried by the PDCCH payload, allocated size of each individual DCI, possible header. These parameters may be common for all client devices 200 configured to operate according to the second configuration and according to the same search space ID, which can be configured using RRC signalling common for a plurality of client devices 200, or using dedicated RRC signalling.

In addition to common parameters related to the aforementioned common parameters for the second configuration, the client device 200 may be configured with dedicated, or DCI-specific, parameters related to the second configuration. These parameters can include one or more of the following information elements: a header, one or more dedicated/individual RNTIs, and size of each individual DCI, with or without RNTI.

When the client device 200 receives a PDCCH payload matching with the preconfigured multi-DCI RNTI, the client device 200 may determine the presence of dedicated/individual DCIs in the PDCCH payload. This can be based on the RNTI or a header included in the PDCCH payload, as well as the preconfigured structure of the PDCCH payload.

Further features of the network node device 210 may directly result from the functionalities and parameters of the client device 200 and thus are not repeated here.

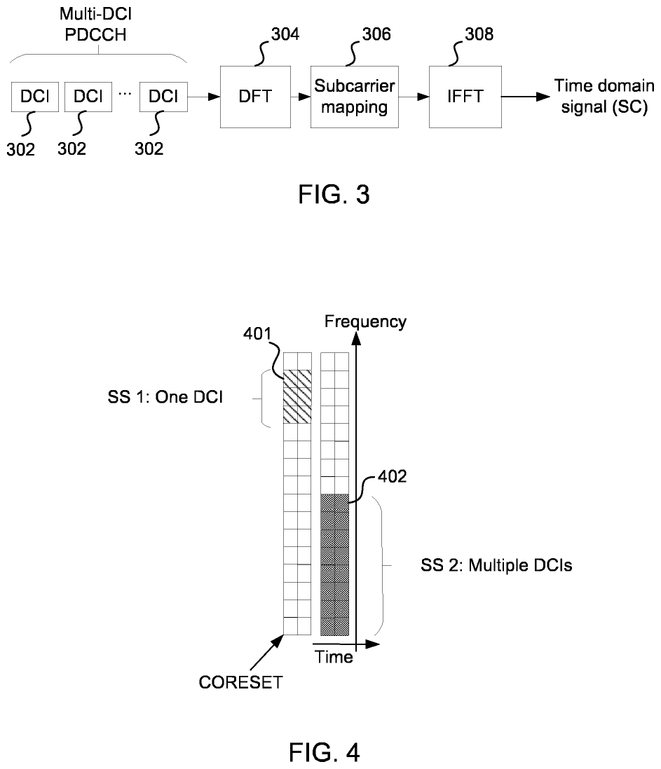

FIG. 3 illustrates an example of generating a single carrier PDCCH, according to an example embodiment. A plurality of DCI blocks 302 may be translated to frequency domain, for example by a discrete Fourier transform (DFT) operation 304. However, DFT is provided only as an example and signal processing in the frequency domain may not be limited to DFT only. For example, operation 304 may also comprise amplitude weighting in frequency. The frequency domain samples may be then mapped to subcarriers. The plurality of DCI blocks may be mapped to the subcarriers in accordance with resources allocated to the PDCCH channel. The plurality of DCI blocks may be time division multiplexed with each other. Subcarrier mapping may further involve including reference signals to predetermined subcarriers. In an example embodiment, reference signals may be time division multiplexed with DCI. The frequency domain samples may be then translated back to time domain, for example by an inverse fast Fourier transform (IFFT) operation 308 to obtain a time domain signal. It is noted that since all DCI blocks 302 are subject to the same DFT operation, the time domain signal may be considered to be a single carrier signal having desired PAPR properties.

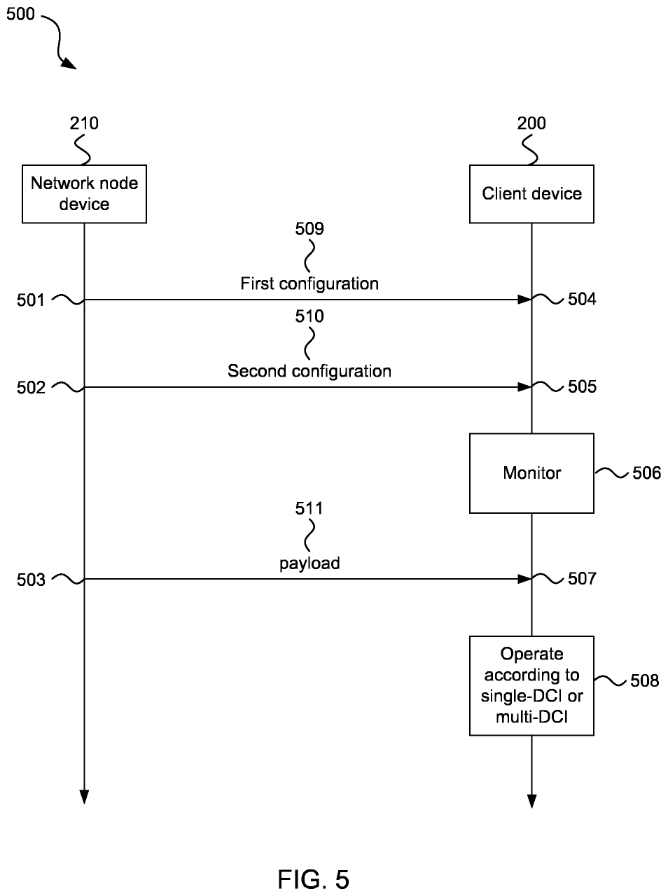

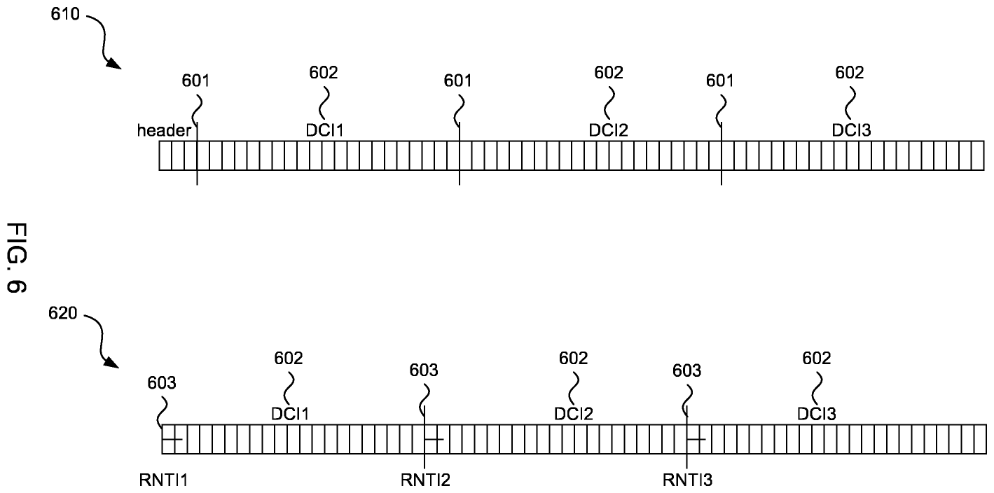

FIG. 4 illustrates two search spaces corresponding to different physical layer resources. As described herein, a client device may be configured with a plurality of search spaces, which may be used by the client device to find downlink control information. A first search space (SS) may be configured to comprise a single DCI block. A second search space may be configured to comprise a plurality of DCIs. The first and second search spaces may or may not be associated with the same CORESET. A network node device 210 may be configured to provide downlink control information in physical layer resources belonging to the first and/or the second search space. A client device 200 may be configured, for example based on a radio resource control (RRC) message received from network node device 210, to monitor both the first and the second SS, as will be further described in connection with FIG. 5. It is appreciated that even though the first and second SSs have been illustrated to be located at neighboring CORESETs, example embodiments may apply also a higher number of SSs. Furthermore, the SS-SETs may comprise any sets of physical layer resources configured to carry a DCI block or a plurality of DCI blocks.

FIG. 5 illustrates an example signaling diagram of a method 500, in accordance with an example embodiment. At 501, network node device 210 may send a first configuration message 509 including an indication of a first physical downlink control channel configuration. The first PDCCH configuration may be provided for example in a radio resource control (RRC) message and may comprise information for example of the first search space 401. At 504, the client device 200 may receive the first configuration message 509.

At 502, network node device 210 may send a second configuration message 510 including an indication of a second physical downlink control channel configuration. The second PDCCH configuration may be provided for example in a radio resource control (RRC) message and may comprise information for example of the second search space 402. At 505, the client device 200 may receive the second configuration message 509. In response to receiving the first and second configuration messages 509, 510, the client device 200 may initiate monitoring of physical layer resources according to the first and second configurations at 506. At 503, the network node device 210 may send PDCCH payload 511 data according to the first configuration or the second configuration. As discussed above, payload data transmitted according to the first configuration may comprise a single DCI block and payload data transmitted according to the second configuration may comprise a plurality of DCI blocks. In response to finding payload data 511 corresponding to the first configuration at 507, client device may operate according to a DCI block comprised in the payload data at 508.

In response to finding payload data 511 corresponding to the second configuration at 507, client device may operate according to a DCI block comprised in the payload data, the client device 200 may determine presence of at least one dedicated downlink control information block in the plurality of downlink control information blocks, and operate according to the at least one dedicated downlink control information block at 508.

FIG. 6 illustrates an example embodiment of payload data for multi-DCI. Structure of the payload data, such as the first payload data and/or the second payload data, may be configured by higher layer signaling, such as radio resource control, RRC. The PDCCH configuration may comprise the number of individual DCIs per PDCCH payload data. The PDCCH configuration may comprise the number of bits available for each individual DCI. For some client devices 200, the actual size of the DCI may be smaller than the number of bits allocated for each individual DCI position. In such a case, the remaining excess bits may be filled with padding bits, e.g. zero padding. The PDCCH configuration may comprise the starting point of each individual DCI.

In particular, FIG. 6 illustrates two example embodiments of payload data transmitted according to the second PDCCH configuration. According to one example, the payload data 610 may be comprise a header 601. The header 601 may comprise one or more identifications of a UEs, for example short IDs corresponding to one or more UEs. The client device 200 may be configured with a short ID and the short IDs listed in the header may be used by the client device 200 to determine which DCI(s) are dedicated to itself. The header 601 may comprise, for example, a 5-bit short ID for each DCI 602 comprised in the payload data 610. There may be a one-to-one mapping between the short ID and the DCI blocks payload. For example, the first short ID may map to the first DCI block.

According to another example, determining whether a DCI is directed to a particular UE may be based on client specific RNTI or RNTIs 603. The client device 200 may compare predefined bits within the payload data 620, for example at the beginning of a DCI block, with respect to RNTI or RNTIs. When the client device 200 finds a matching RNTI 602, it may consider the particular DCI block as a relevant DCI block for the client device 200. In the case of Multi-DCI there can be multiple RNTIs configured for a UE. In addition to client specific RNTI 602, there can be another RNTI, a common RNTI 603 for a plurality of users configured to use multi-DCI. According to an example embodiment, the client device 200 may use the common RNTI 603 for determining whether a multi-DCI has transmitted by gNB. In other words, client device 200 may use the common RNTI to determine presence of multi-DCI, and client specific RNTI 602 to determine presence of client specific info (i.e. relevant DCI block dedicated for the client device 200) within determined multi-DCI.

In both examples of FIG. 6, the payload of a plurality of DCIs is concatenated. The horizontal axis FIG. 6 corresponds to DCI bits. For simplicity, RNTI related to multi-DCI is not shown in FIG. 6. The RNTI related to multi-DCI may be attached to the payload data 620. Alternatively, cyclic redundancy check bits may be determined based on the payload data 620 and scrambled with the bits of the RNTI related to the multi-DCI before attaching them to the payload. In this case, client device 200 may use the common RNTI to determine presence of multi-DCI by taking the scrambling with the common RNTI into account when performing cyclic redundancy check for the received payload.

The different DCIs may be scrambled with client/RNTI-specific scrambling code. Thus, client devices 200 configured with the same RNTI cannot read the DCI of other client devices 200.

At least some of the example embodiments described herein may improve multiplexing capacity/spectrum efficiency for single carrier-based PDCCH.

At least some of the example embodiments described herein may improve scalability of PDCCH transmission.

At least some of the example embodiments described herein may provide spectral efficient transmission of single DCI for a UE, provide spectral efficient transmission of a plurality of DCIs for a UE (simultaneous such as DL and UL grant, and/or provide spectral efficient transmission of a plurality of DCIs for a plurality of UEs.

At least some of the example embodiments described herein may enable to maintain single carrier properties of the transmitted signal in all scenarios.

At least some of the example embodiments described herein may allow the network node device 210 to have full flexibility to select the preferred DCI strategy (one or more DCI) based on the actual traffic/coverage situation in the cell.

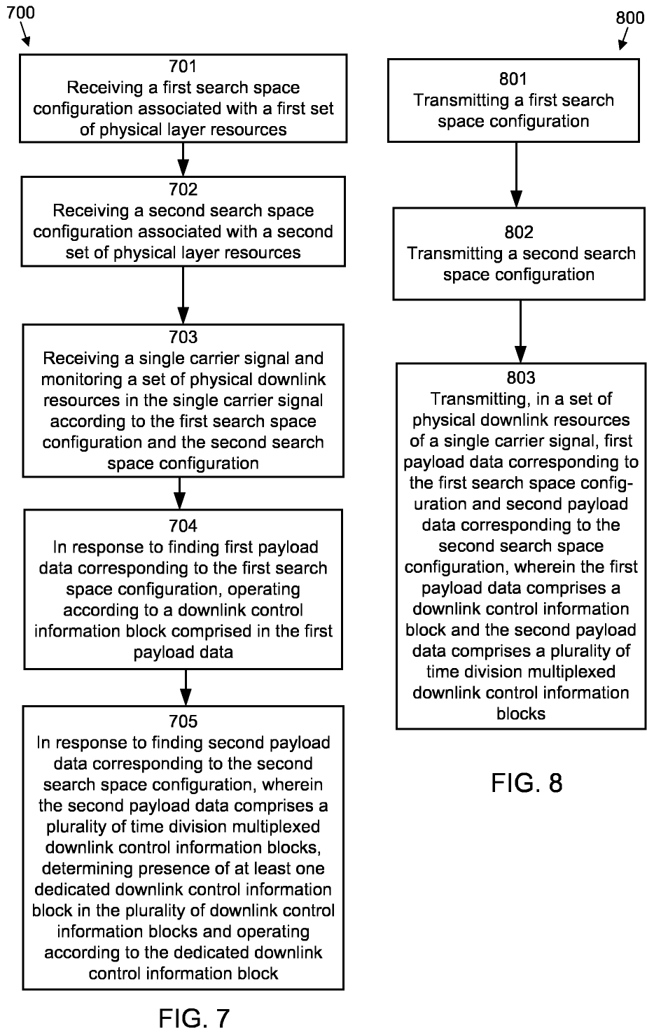

FIG. 7 illustrates an example of a method for finding downlink control information, according to an example embodiment.

In operation 701, the method may comprise receiving a first search space configuration associated with a first set of physical layer resources.

In operation 702, the method may comprise receiving a second search space configuration associated with a second set of physical layer resources.

In operation 703, the method may comprise receiving a single carrier signal and monitoring a set of physical downlink resources in the single carrier signal according to the first search space configuration and the second search space configuration.

In operation 704, the method may comprise, in response to finding first payload data corresponding to the first search space configuration, operating according to a downlink control information block comprised in the first payload data.

In operation 705, the method may comprise, in response to finding second payload data corresponding to the second search space configuration, wherein the second payload data comprises a plurality of time division multiplexed downlink control information blocks, determining presence of at least one dedicated downlink control information block in the plurality of downlink control information blocks and operating according to the dedicated downlink control information block.

According to an example embodiment, a downlink grant and an uplink grant may be provided to a first user equipment. Alternatively, or additionally, a downlink grant or an uplink grant may be provided to the first user equipment and a downlink grant or an uplink grant may be provided to at least one second user equipment. In one example embodiment, the downlink grant or uplink grant may be provided to a plurality of second user equipment.

According to an example embodiment, the method may further comprise any operation performed by apparatus 200.

FIG. 8 shows an example a method for providing downlink control information, according to an example embodiment illustrates an example of a method for finding

In operation 801, the method may comprise transmitting a first search space configuration.

In operation 802, the method may comprise transmitting a second search space configuration.

In operation 803, the method may comprise transmitting, in a set of physical downlink resources of a single carrier signal, first payload data corresponding to the first search space configuration and second payload data corresponding to the second search space configuration, wherein the first payload data comprises a downlink control information block and the second payload data comprises a plurality of time division multiplexed downlink control information blocks.

According to an example embodiment, the method may further comprise any operation performed by apparatus 210.

It is to be understood that the order in which operations 701 to 705 or 801 to 803 are performed, may vary from the examples depicted in FIG. 7 and FIG. 8. The method 700, or any variations thereof as described herein, may be configured to be performed by an apparatus, for example the client device 200 of FIG. 2A. Method 800, or any variations thereof as described herein, may be configured to be performed by an apparatus, for example the network node device 210 of FIG. 2B. Further features of the methods 700 or 800 directly result from the functionalities and parameters of the network node device 210 and the client device 200 and thus are not repeated here. The methods 700 or 800 can be performed by computer program(s).

An apparatus may comprise means for performing any aspect of the method(s) described herein. According to an example embodiment, the means comprises at least one processor, and memory including program code, the at least one processor, and program code configured to, when executed by the at least one processor, cause performance of any aspect of the method.

The functionality described herein can be performed, at least in part, by one or more computer program product components such as software components. According to an example embodiment, the client device 200 and/or network node device 210 comprise a processor configured by the program code when executed to execute the example embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and Graphics Processing Units (CPUs).

Any range or device value given herein may be extended or altered without losing the effect sought. Also, any example embodiment may be combined with another example embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one example embodiment or may relate to several example embodiments. The example embodiments are not limited to those that solve any or all of the stated problems or those that have any or all of the stated benefits and advantages. It will further be understood that reference to ‘an’ item may refer to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the example embodiments described above may be combined with aspects of any of the other example embodiments described to form further example embodiments without losing the effect sought.

The term ‘comprising’ is used herein to mean including the method, blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various example embodiments have been described above with a certain degree of particularity, or with reference to one or more individual example embodiments, those skilled in the art could make numerous alterations to the disclosed embodiments without departing from the scope of this specification.

1. An apparatus, comprising:
at least one processor; and
at least one memory including computer program code;
the at least one memory and the computer program code configured to, with the at least one processor, cause the apparatus to:
receive a first search space configuration associated with a first set of physical layer resources;
receive a second search space configuration associated with a second set of physical layer resources;
receive a single carrier signal and monitor a set of physical downlink resources in the single carrier signal according to the first search space configuration and the second search space configuration;
in response to finding first payload data corresponding to the first search space configuration, operate according to a downlink control information block comprised in the first payload data; and
in response to finding second payload data corresponding to the second search space configuration, wherein the second payload data comprises a plurality of time division multiplexed downlink control information blocks, determine presence of at least one dedicated downlink control information block in the plurality of downlink control information blocks and operate according to the dedicated downlink control information block.

2. The apparatus according to claim 1, wherein the second payload data comprises at least one of:
a downlink grant and an uplink grant for a first user equipment; or
a downlink grant or uplink grant for the first user equipment and a downlink grant or uplink grant for at least one second user equipment.

3. The apparatus according to claim 1, wherein the second search space configuration comprises one or more common parameters for a plurality of user equipment, the common parameters comprising at least one of:
a search space identification;
an aggregation level;
a size of the second payload data;
a common radio network temporary identification; or
data indicating a structure of the second payload data.

4. The apparatus according to claim 3, wherein the data indicating the structure of the second payload data comprises at least one of:
a number of downlink control information blocks in the second payload data;
a maximum size of at least one downlink control information block in the second payload data; or
a starting point of at least one downlink control information block in the second payload data.

5. The apparatus according to claim 1, wherein the first search space configuration comprises a first CORESET or CORESET configuration and the second search space configuration comprises a second CORESET or CORESET configuration.

6. The apparatus according to claim 5, wherein the first CORESET or CORESET configuration and/or the second CORESET or CORESET configuration comprise downlink control information time division multiplexed with a downlink demodulation reference signal.

7. The apparatus according to claim 5, wherein the first CORESET and the second CORESET are the same CORESET or two different CORESETs.

8. The apparatus according to claim 1, wherein the second search space configuration comprises at least one radio network temporary identifier dedicated to a user equipment.

9. The apparatus according to claim 1, wherein the second payload data comprises a header identifying a user equipment for each subsequent downlink control information block.

10. The apparatus according to claim 1, wherein each of the plurality of downlink control information blocks comprises a radio network temporary identifier.

11. The apparatus according to claim 1, wherein the at least one memory and the computer program code are further configured to, with the at least one processor, cause the apparatus to:
determine the presence of the second payload data based on the common radio network temporary identifier.

12. The apparatus according to claim 1, wherein the at least one memory and the computer program code are further configured to, with the at least one processor, cause the apparatus to:
determine the presence of the at least one dedicated downlink control information block in the second payload data based on the header, or the radio network temporary identifier.

13. An apparatus, comprising:
at least one processor; and
at least one memory including computer program code;
the at least one memory and the computer program code configured to, with the at least one processor, cause the apparatus to:
transmit a first search space configuration;
transmit a second search space configuration;
transmit, in a set of physical downlink resources of a single carrier signal, first payload data corresponding to the first search space configuration and second payload data corresponding to the second search space configuration, wherein the first payload data comprises a downlink control information block and the second payload data comprises a plurality of time division multiplexed downlink control information blocks.

14. The apparatus according to claim 13, wherein the second payload data comprises at least one of:
a downlink grant and an uplink grant for a first user equipment; or
a downlink grant or uplink grant for the first user equipment and a downlink grant or uplink grant for at least one second user equipment.

15. The apparatus according to claim 13, wherein the at least one memory and the computer program code are further configured to, with the at least one processor, cause the apparatus to:
set the first search space configuration and the second search space configuration based on an amount of traffic in a cell.

16. The apparatus according to claim 13, wherein the at least one memory and the computer program code are further configured to, with the at least one processor, cause the apparatus to:
set the first search space configuration and the second search space configuration separately for different transmission beams.

17. The apparatus according to claim 13, wherein the second search space configuration comprises one or more common parameters for a plurality of user equipment, the common parameters comprising at least one of:
a search space identification;
an aggregation level;
a size of the second payload data;
a common radio network temporary identification; or
data indicating a structure of the second payload data.

18. The apparatus according to claim 13, wherein the data indicating the structure of the second payload data comprises at least one of:
a number of downlink control information blocks in the second payload data;
a maximum size of at least one downlink control information block in the second payload data; or
a starting point of at least one downlink control information block in the second payload data.

19.-25. (canceled)

26. A method, comprising:
receiving a first search space configuration associated with a first set of physical layer resources;
receiving a second search space configuration associated with a second set of physical layer resources;
receiving a single carrier signal and monitoring a set of physical downlink resources in the single carrier signal according to the first search space configuration and the second search space configuration;
in response to finding first payload data corresponding to the first search space configuration, operating according to a downlink control information block comprised in the first payload data; and
in response to finding second payload data corresponding to the second search space configuration, wherein the second payload data comprises a plurality of time division multiplexed downlink control information blocks, determine presence of at least one dedicated downlink control information block in the plurality of downlink control information blocks and operating according to the dedicated downlink control information block.

27. A non-transitory computer readable medium storing a program of instructions, execution of which by a processor configures an apparatus at least to perform a method according to claim 26.

28.-29. (canceled)
